(19) United States
(12) Patent Application Publication
(10) Pub. No.: US 2022/0266186 A1
(43) Pub. Date: Aug. 25, 2022

(54) APPARATUS AND METHOD FOR HANDLING AIRBORNE SUBSTANCES AND/OR A MULTILAYERED STRUCTURAL MEMBER

(71) Applicants: Arie Shimon Ben Kalifa, Migdal HaEmek (IL); Mohammad Abu Rabia, Meitar (IL)

(72) Inventors: Arie Shimon Ben Kalifa, Migdal HaEmek (IL); Mohammad Abu Rabia, Meitar (IL)

(21) Appl. No.: 17/676,953

(22) Filed: Feb. 22, 2022

Related U.S. Application Data
(60) Provisional application No. 63/151,805, filed on Feb. 22, 2021.

(51) Int. Cl. B01D 46/46; B01D 46/00; B01D 46/42; B01D 46/44; B64C 39/02; B64D 1/00

(52) U.S. Cl. CPC B01D 46/46; B01D 46/0006; B01D 46/4227; B01D 46/442; B64C 39/024; B64D 1/00; B01D 2279/40; B64C 2201/12

(57) ABSTRACT

A system for harvesting airborne substances includes a first sampling airborne apparatus and a second primary airborne apparatus. The second primary airborne apparatus is controlled to harvest airborne substances according to data obtained by the sampling airborne apparatus.

### TECHNICAL FIELD

Embodiments of the invention relate to apparatus and method for handling airborne substances, for example for harvesting greenhouse gas emissions, and/or to a multilayered structural member.

### BACKGROUND

Handling airborne substances may relate to harvesting such substances from the air and/or to seeding such substances into the air.

In the context of harvesting it is known that airborne substances driven by humans, such as greenhouse gas emissions, affect weather patterns that in turn result in worsening habitat conditions, which can be exemplified by rising temperatures, increased water vapor, changes to land and ocean carbon sinks (etc.). Therefore being able to harvest such substances from the air is an increasing aim.

Greenhouse gas emissions resulting from industrial activity are mainly attributed to burning fossil fuels for energy, from certain chemical reactions necessary to produce goods from raw materials (and the like).

Significant amounts of airborne substances are typically emitted to the ambient environment via flue-gas stacks (i.e. Industrial chimneys)—and various measures are considered for limiting the amount of substances harmful to the environment from reaching Earth's atmosphere.

Seeding substances into the air may be implemented e.g. by spraying various types of substances into the air, such as in firefighting, spraying insecticides, spraying disinfectants e.g. against viruses (or the like).

Structural members play an important role in imparting mechanical properties to a variety of apparatuses, such as airborne or non-airborne devices (and the like). Mechanical properties that are desirable may include strength to withstand impact or maintain a designed structural geometry during use, while maintaining relative light weight.

### SUMMARY

The following embodiments and aspects thereof are described and illustrated in conjunction with systems, tools and methods which are meant to be exemplary and illustrative, not limiting in scope.

In an embodiment there is provided an apparatus for handling airborne substances comprising a main body and lift members for controlling ascent and descent of the apparatus, wherein the main body comprises spaced apart generally parallel ribs and substance handling members placed in between ribs for handling airborne substances.

Possibly, handling airborne substances comprises harvesting airborne substances.

Possibly at least some of the substance handling members are filter members.

Possibly, at least some of the ribs comprise wooden plates, wherein possibly a rib comprising sponge material sandwiched between wooden plates.

Possibly, at least some of the ribs comprise apertures for permitting air flow therethrough.

Possibly, at least some fan members associated each with a respective aperture in a rib for urging air flow through the rib.

Possibly, the lift members comprise propellers and/or lifting bags.

Possibly, the main body being foldable by urging rib members closer together while being kept generally parallel one to the other.

Possibly, the apparatus comprising a covering for shielding a top region of the main body.

Possibly, a lower region of the main body remains un-shielded by the covering.

Possibly, the covering being detachably attached to the main body, possibly by snap fit engagement.

Possibly, at least some of the substance handling members being detachably attached each to the main body between adjacent ribs.

Possibly, a substance handling member is a filter member and the filter comprises a casing and filter material located within the casing.

Possibly, the apparatus being remotely controlled for operation.

Possibly, the apparatus of any one of the preceding claims and being of an un-crewed aerial vehicle type.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIGS. 1A and 1B schematically show an embodiment of an apparatus for handling airborne substances in accordance with the present invention;

FIG. 2 schematically shows a rib suitable for being used in an apparatus for handling airborne substances such as that seen in FIGS. 1;

FIGS. 3A and 3B schematically show a side view of an apparatus for handling airborne substances such as that seen in FIGS. 1, and lifting bags of the apparatus in inflated and deflated states;

FIGS. 4A and 4B schematically show top views of a main body of an apparatus for handling airborne substances such as that seen in FIGS. 1, including a plurality of spaced apart ribs;

FIG. 5 schematically shows a top view of an apparatus for handling airborne substances such as that seen in FIGS. 3, with a shield covering its main body;

FIGS. 6A and 6B schematically show an embodiment of a filter member suitable for being places in between ribs of an apparatus for handling airborne substances such as those seen in the former figures;

FIGS. 7A, 7B and 7C schematically show, respectively, a side view of an apparatus for handling airborne substances including an instrument module at its lower side, a detailed view of an embodiment of an instrument module, and a top view of a section of an apparatus for handling airborne substances where such an instrument may be fitted;

FIG. 8 schematically show a primary collecting (PC) airborne apparatus for harvesting airborne substances, and for interacting with former shown apparatuses for handling airborne substances that act as sampling modules (SM); and

FIGS. 9A to 9E schematically show various embodiments of multilayered structural members in accordance with an independent aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

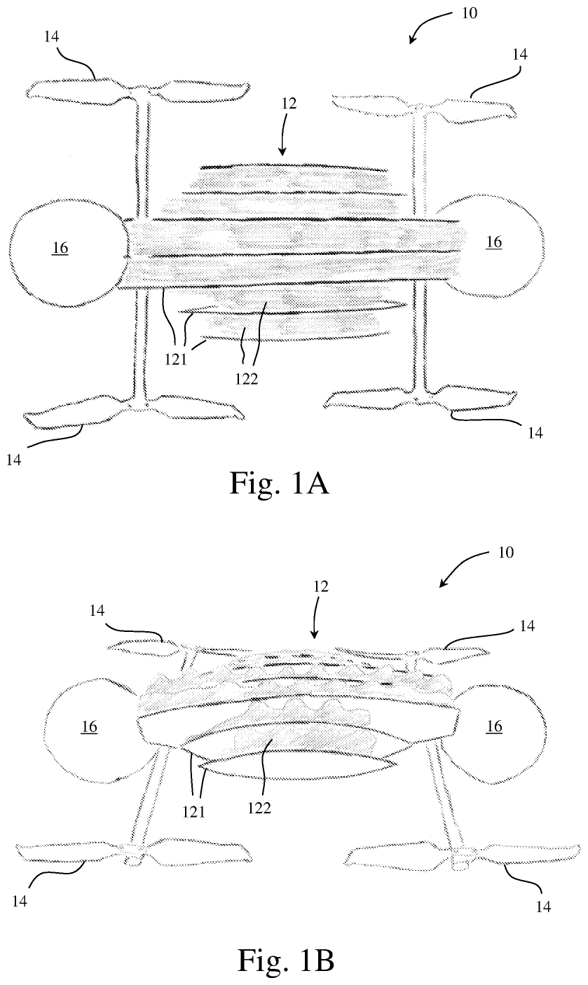

Attention is first drawn to FIGS. 1A and 1B schematically illustrating an embodiment of an airborne apparatus 10 for handling airborne substances in accordance with the present invention. The various apparatus embodiments described herein may be suited to assume an airborne position in order to handle airborne substances and then land to possibly safely dispose the substances in case when such handling is in the form of harvesting airborne substances as will be the main example referred to herein-below in the context of at least certain embodiments.

Possibly such airborne position where harvesting may take place may be above a region emitting airborne substances (such as flue-gas stacks or the like) where typical airborne substances may include greenhouse gaseous (or the like). After safely disposing the harvested airborne substances, such an apparatus may re assume an airborne position to continue the harvesting.

Apparatus 10 may be of an un-crewed aerial vehicle type and may include a main body 12, landing gears 13 (see FIG. 3A) fitted in this example to the main body and lifting members, in this example in the form of propellers 14 and optional lifting bags (e.g. balloons) 16, for controlling ascent and descent of the apparatus. Main body as seen in these views may include several spaced apart ribs 121 and filter members 122 located in spacing's formed between adjacent ribs.

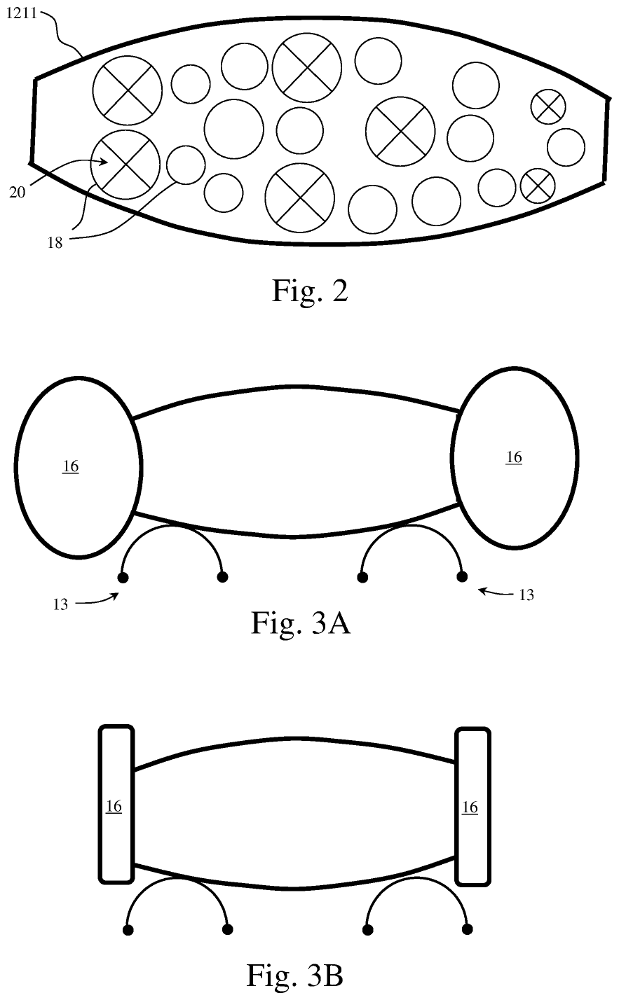

Attention is drawn to FIG. 2 illustrating an embodiment of a rib 1211 from a side view. As seen, the illustrated rib may include openings 18 through the rib, some of which may optionally include fan members 20 for urging air flow through the rib. Such ribs 1211 may be included in an apparatus such as that seen in FIGS. 1, and may form part or all of the ribs of the apparatus.

Attention is drawn to FIGS. 3A and 3B showing a side view of an apparatus for harvesting airborne substances that includes optional lifting bags 16. In at least certain embodiments, the lifting bags 16 as seen may be adapted to assume an inflated state (FIG. 3A) suitable for assisting in lifting the apparatus upwards and a deflated state (FIG. 3B) indicative of low or zero assistance in lift for the apparatus. The lifting bags in the various embodiments described herein may assist in urging upward lift by being filled with gas that is lighter than air.

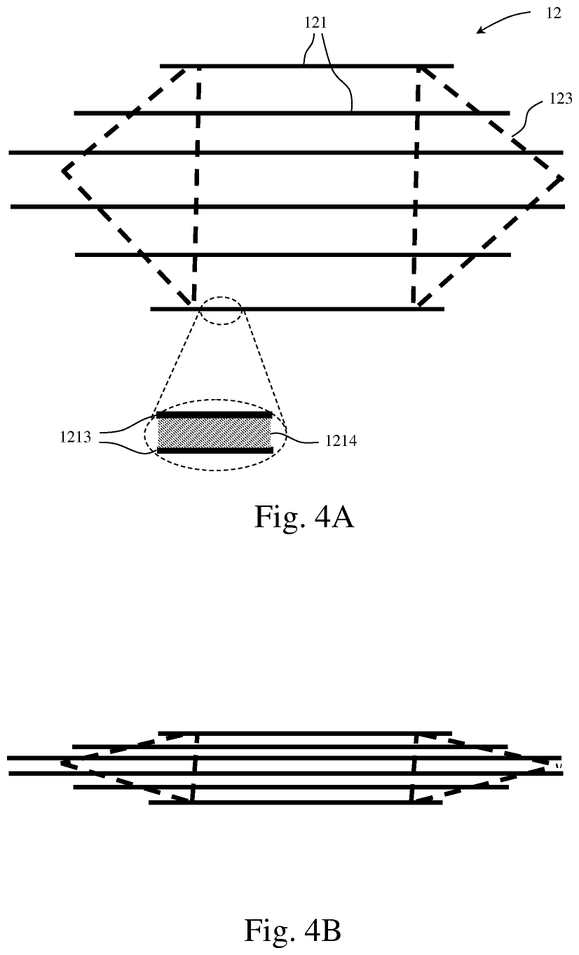

Attention is drawn to FIG. 4A schematically illustrating a top view of an embodiment of a main body 12 of an apparatus for harvesting airborne substances. As seen in this example, beams 123, possibly formed from light weight material such as aluminum, may be used for supporting the ribs 121 in place.

In the enlarged section at the lower side of FIG. 4A, a possible rib embodiment can be seen formed from two wooden plates 1213 that sandwich sponge material 1214 in between. Such sandwich structure provides on the one hand a strong formation while maintaining relative light weight that is favorable for an airborne apparatus.

FIG. 4B illustrates a possible embodiment where a main body of the apparatus may be foldable when not in use and when not including sponge members in between adjacent ribs. Such folded state may be characterized by ribs being urged closer together, and may be suitable e.g. for storage of the apparatus when not in use.

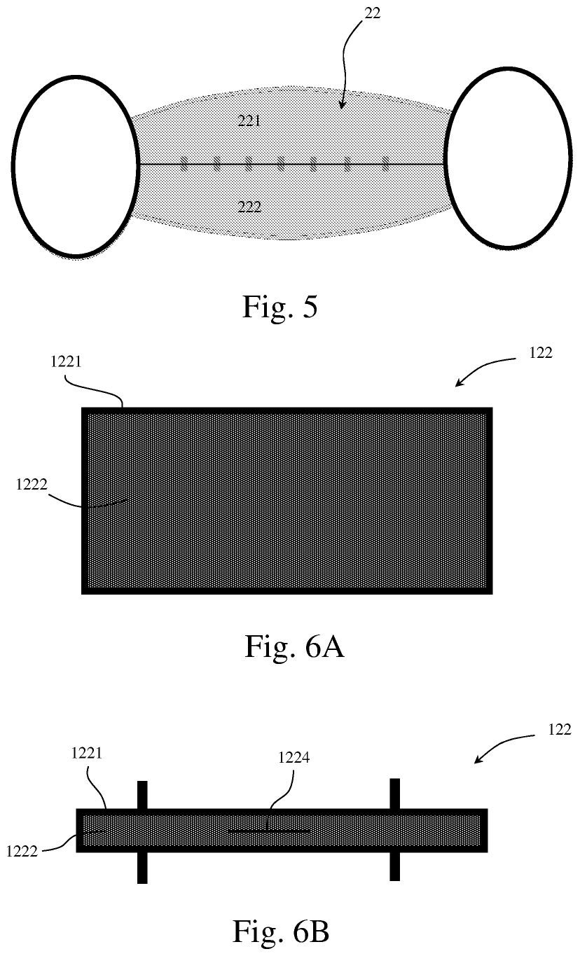

Attention is drawn to FIG. 5 illustrating a possible covering 22 that may be fitted to a top region the apparatus' main body. Covering 22 may be adapted to conceal the main body so that the apparatus can function for harvesting in relative harsh (e.g. rainy) weather conditions, while preferably leaving a lower side of the main body open to permit inlet suction of airborne substances for harvesting in the apparatus. The Covering 22 may be formed from two parts 221, 222 that snap fit onto one of the ribs to be kept in place during use.

Attention is drawn to FIGS. 6A and 6B illustrating an embodiment of a filter member 122 suitable for being placed in between adjacent ribs of an apparatus. In this example, the filter member may be arranged in a so-called drawer formation by providing a frame 1221, possibly from aluminum, which encloses filter media 1222. Such frame may include apertures for permitting airflow through the filter member.

In a non-binding example, the filter media may be of a pre-filter and/or fine dust filter type, and may be similar or may include filtering materials in available products, such as those provided by MANN+HUMMEL GMBH (e.g. the Airmat, Airroll, Airpad etc. product lines).

Such drawer formation may facilitate easy loading and unloading of filter members into the apparatus. Loading may be arranged to be accomplished by snap fitting such filter member 122 into place in between adjacent ribs. Such drawer formation filter member may include a handle 1224 for easy manual manipulation of the filter member into and out of the apparatus.

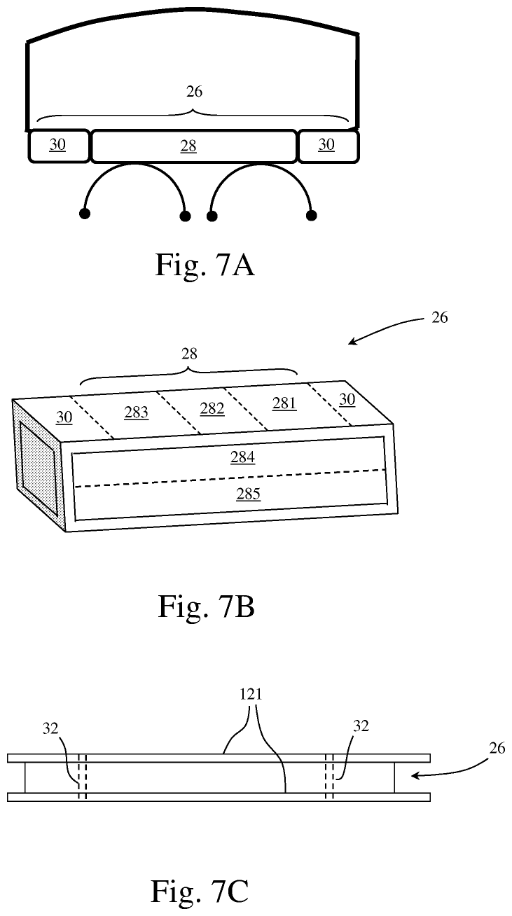

Attention is drawn to FIGS. 7A to 7C for an illustration of an instrument module 26 of an apparatus for harvesting airborne substances. The instrument module in this example may include an electronics module 28 and power modules 30 (e.g. batteries) for providing electrical power to the electronics module. In a non-binding example, the batteries may be Lithium Polymer batteries, such as those provided by Jeti USA.

FIG. 7B provides a view of a possible instrument module 26, in this example including within its electronics module 28: a GPS member 281, an automatic pilot module 282 and a motor control module 283. The power modules 30 in this example may be placed on both sides of the electronics module and thus may be easily replaceable. Also seen is that the instrument module may be divided into upper 284 and lower 285 compartments. Location of the instrument module close to a lower side of the apparatus may facilitate easy maintenance, and possible easy replacement of parts therein.

FIG. 7C provides a view illustrating possible attachment of an instrument module 26 within the apparatus. In this shown example, such attachment may be accomplished by securing an instrument module in between adjacent ribs 121 of the apparatus by fastening members 32 that pass through bores formed in the ribs and instrument module.

In certain embodiments, the amount of substances harvested by an airborne apparatus for harvesting airborne substances may be monitored. Such monitoring may assist in detecting when filter media of the apparatus is substantially saturated with harvested substances, and should be controlled to land for safe disposable of the substances. Such safe disposing may be accomplished by replacing the filter media with new clean filters, or by cleaning the filter media for repeated use.

In one example, the monitoring of the filter media may be accomplished by means of cameras, for example infrared cameras, suited to detect presence of harvested particles.

An airborne apparatus for harvesting airborne substances may be remotely controlled by an automated computerized control module, and may include a telemetric system for measuring collecting and/or transmitting data to and/or from the apparatus to a remote controller. Engines powering flight of an apparatus may be electric or a hybrid combination of electric and internal combustion engines.

Data collected by certain apparatus embodiments may be used for mapping e.g. areas where presence of harvested substances has been detected. Data collected by certain apparatus embodiments may also be used for assisting in weather forecasting.

In certain apparatuses for handling airborne substances, the filter members 122 may be released from the body of the apparatus while still in mid-air. For example, a releasing mechanism implemented in various ways (e.g. spring release, etc.) may be used for releasing filter members from the apparatus.

In an aspect of the present disclosure, the various apparatuses for handling airborne substances described herein above, may act as examples of sampling modules (SM) that are used for sampling presence of airborne substances, possibly in an autonomous way.

Possibly, sampling different zones within a certain given region by such sampling modules (SM) may include landing and replacing the filters that sample a first zone within the given region, before lifting back up again with new or cleaned filters to sample another second zone within the given region. It is noted that sampling modules (SM) may be of various types, such as with abilities to sense presence of airborne substances not via filters, but through various types of sensing means.

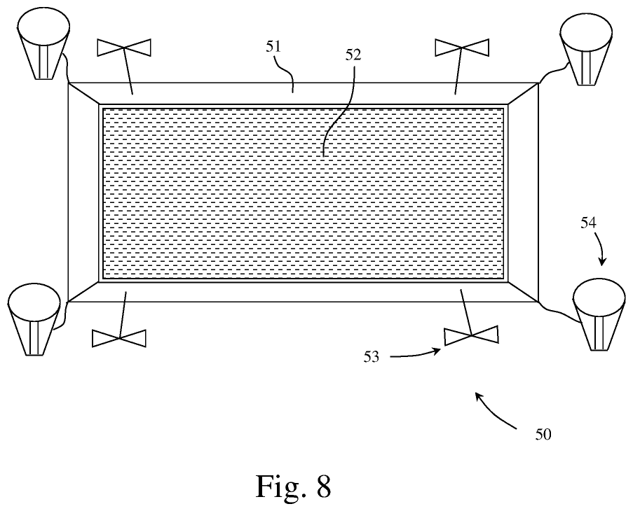

In an embodiment, such sampling modules (SM) may be activated substantially continuously to sample zones of a region, in order to direct a primary collecting (PC) airborne apparatus 50, such as that illustrated in FIG. 8, to then harvest larger quantities of substances.

Attention is drawn to FIG. 8 showing a schematic illustrating of one optional example that such a primary collecting (PC) airborne apparatus 50 may assume. As seen, in this example the primary collecting (PC) airborne apparatus 50 includes an enclosure 51 surrounding a relative large sized filter 52. Primary apparatus (PC) further includes in this optional example, propulsion members 53, here four such members, and lifting members 54, here also four such members.

Operation of primary apparatus (PC) 50, as aforementioned, may be guided by information gathered by one or more sampling modules (SM), and the primary apparatus 50 may be piloted in an autonomous manner to harvest airborne substances according to such guidance.

When filter 52 of the primary apparatus 50 is substantially saturated, the primary apparatus 50 may be controlled to land to dispose the harvested substances from the filter. Such disposing of harvested substances in one example may be by cleaning the filter 52 and collecting the removed harvested substances, possibly for further processing (e.g. refining).

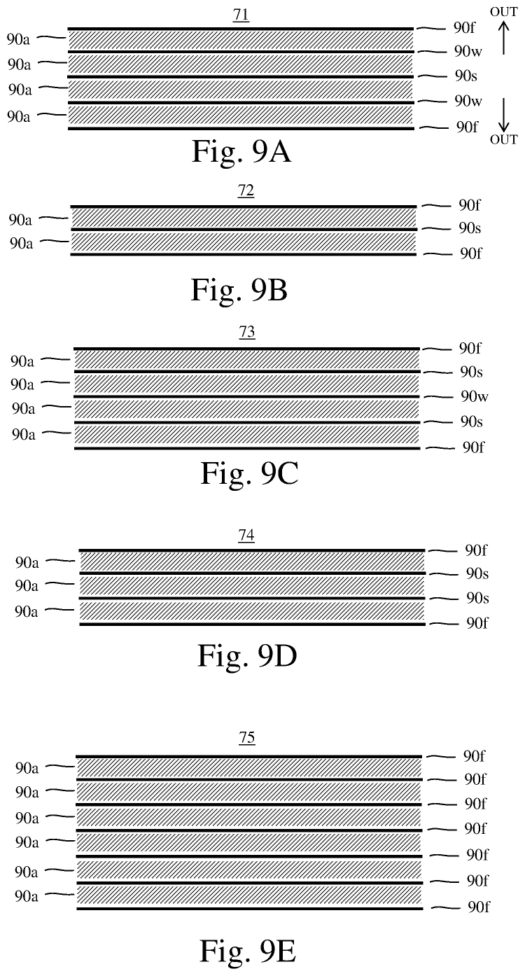

Attention is drawn to FIG. 9A to 9E illustrating multilayered structural members in accordance with an aspect of the present invention, that may be used in airborne apparatus, such as those disclosed herein. For example, the described ribs (such as 121) or enclosure (such as 51) may be formed from multilayered structural member embodiments, such as those disclosed herein.

Possibly, such multilayered structural members may be used in a variety of applications not necessarily relating to airborne devices. For example, such multilayered structural members may be used in vehicles (e.g. in a Chassis), in structures such as containers (e.g. bins), in marine vessels, in floor tiles (etc.).

In tests performed by the inventors, such multilayered structural members have been found to exhibit superior mechanical strength properties, while being relative lightweight, and relatively easily moldable to assume desired shapes.

The multilayered structural member 71 seen in FIG. 9A can be seen including outer fiberglass and more inner adjacent wooden layers 90f, 90w located on both sides of a central silicone layer 90s. An adhesive stratum 90a, preferably a hot-melt adhesive (such as epoxy or the like) is located in this example between each pair of adjacent layers.

In a non-bonding example, a total thickness of structural member 71 may be several millimeters, e.g. about seven millimeters.

In the various structural member embodiments disclosed herein, the wooden (e.g. maple) layers 90w may act for acoustic purposes and for dampening electromagnetic disturbances from passing through the structural member, and the silicone layer 90s may act for limiting vibrations and noise in the structural member.

In one example, multilayered structural members disclosed herein may be formed by fastening together the layers and stratums using heat, e.g. in an oven.

The multilayered structural member 72 in FIG. 9B exemplifies a thinner formation (e.g. of several millimeter in thickness) and can be seen including outer fiberglass layers 90f located on both sides of a central silicone layer 90s. An adhesive stratum 90a is located in this example between adjacent layers.

Sediment such as sand, possibly of silica composition, may be included in adhesive stratum 90a in the various structural member embodiments disclosed herein. The addition of sediment has been found to at least partially stabilize the material of the adhesive stratum, possibly imparting to a structural member comprising such “stabilized” adhesive stratum the ability to be moldable into desired shapes according to their application and intended use.

In a non-binding example, sediment added to a material of the adhesive stratum may be at a weight percentage of about 50 wt. % of the weight of the material of the adhesive stratum. For example, if the weight of the material of the adhesive stratum (e.g. the epoxy) is about 200 gram, the weight of the added sediment would be about 100 gram according to this example.

The multilayered structural member 73 in FIG. 9C can be seen including outer fiberglass and more inner adjacent silicone layers 90f, 90s located on both sides of a central wooden layer 90w. An adhesive stratum 90a is located in this example between adjacent layers. In this example, adjacent adhesive stratums 905 may be formed one with and the other without sediment.

The multilayered structural member 74 in FIG. 9D can be seen including outer fiberglass layers 90f located on both sides of inner silicone layers 90s. An adhesive stratum 90a is located in this example between adjacent layers. In this example, possibly all adhesive stratums 90a include sediment.

The multilayered structural member 75 in FIG. 9E can be seen including possibly only fiberglass layers 90fwith adhesive stratums 90a located therebetween. Possibly, adjacent fiberglass layers 90f are rotated by about 90 degrees one to the other so that weft and warp oriented fibers of one layer are oriented generally aligned with respective warp and weft fibers of an adjacent layer.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A system for harvesting airborne substances comprising a first sampling airborne apparatus and a second primary airborne apparatus, wherein the second primary airborne apparatus is controlled to harvest airborne substances according to data obtained by the sampling airborne apparatus.

2. The system of claim 1, wherein the data obtained by the sampling airborne apparatus is of airborne substances harvested by the sampling airborne apparatus.

3. The system of claim 2 and being arranged to harvest airborne substances within a certain region, and the sampling airborne apparatus being arranged to sample presence of airborne apparatus within different zones of the region and direct the primary airborne apparatus to harvest substances in zones where presence of airborne substances is detected being larger than a certain threshold.

4. The system of claim 3, wherein each one of the sampling and primary airborne apparatuses comprises filters for harvesting airborne substances.

5. The system of claim 3, wherein each one of the sampling and primary airborne apparatuses being arranged to land and release its harvested airborne substances.

6. The system of claim 1, wherein the sampling airborne apparatus and/or the primary airborne apparatus being formed at least partially from a structural member, wherein the structural member comprising at least two layers of material and an adhesive stratum disposed in between the layers.

7. The system of claim 6, wherein the material of the adhesive stratum comprising sediment, such as sand, wherein possibly the sediment may be at a weight percentage of about 50 wt. % of the weight of the material of the adhesive stratum.

8. The system of claim 7, wherein the structural member comprising a wooden layer and/or a silicone layer.

9. The system of claim 7, wherein an adhesive stratum is disposed between each pair of adjacent layers of the structural member.

10. The system of claim 9, wherein outermost layers of the structural member comprise fiberglass.

11. A method for harvesting airborne substances comprising the steps of:
providing a sampling airborne apparatus and a primary airborne apparatus,
launching the sampling airborne apparatus to detect presence of airborne substances within a certain region, and
controlling the primary airborne apparatus to harvest airborne substances according to data obtained by the sampling airborne apparatus.

12. The method of claim 11 and being arranged to harvest airborne substances within a certain region, and the sampling airborne apparatus being arranged to sample presence of airborne apparatus within different zones of the region and direct the primary airborne apparatus to harvest substances in zones where presence of airborne substances is detected being larger than a certain threshold.

13. The method of claim 12, wherein at least one of the sampling and primary airborne apparatuses comprises filters for harvesting airborne substances.

14. The method of claim 12, wherein each one of the sampling and primary airborne apparatuses being arranged to land and release its harvested airborne substances.

15. A structural member for an airborne or other apparatus and comprising a plurality of layers of material and an adhesive stratum disposed in between each pair of adjacent layers.

16. The structural member of claim 15, wherein the material of the adhesive stratum comprising sediment, wherein possibly the sediment may be at a weight percentage of about 50 wt. % of the weight of the material of the adhesive stratum.

17. The structural member of claim 16 and comprising a wooden layer and/or a silicone layer.

18. The structural member of claim 16, wherein outermost layers of the structural member comprise fiberglass.

19. The structural member of claim 16, wherein a central inner layer of the structural member comprises silicone.

20. The structural member of claim 16, wherein the sediment is of silica composition.
